(19) United States
(12) Patent Application Publication
(10) Pub. No.: US 2020/0233146 A1
(43) Pub. Date: Jul. 23, 2020

(54) LIGHTING DEVICE AND DISPLAY DEVICE

(71) Applicant: SHARP KABUSHIKI KAISHA, Sakai City (JP)

(72) Inventors: SHUGO YAGI, Yonago-shi (JP); TAKESHI ISHIDA, Sakai City (JP); YUUICHI KANBAYASHI, Sakai City (JP); SATOSHI TSUBOOKA, Sakai City (JP)

(21) Appl. No.: 16/747,308

(22) Filed: Jan. 20, 2020

(30) Foreign Application Priority Data
Jan. 21, 2019 (JP) 2019-008049

(51) Int. Cl. F21V 8/00; G02F 1/1335

(52) U.S. Cl. CPC G02B 6/0053; G02F 1/133528; G02B 6/0055

(57) ABSTRACT

A lighting device includes a light source, a light guide plate including an edge surface as a light entering surface through which light from the light source enters and one of a pair of plate surfaces as a light exit surface through which the light exits, and a light collecting sheet disposed to cover the light exit surface and applying a light collecting effect to the light exiting through the light exit surface. The light collecting sheet includes a base member having a sheet shape and a non-birefringence property and a light collecting layer disposed on a plate surface of the base member.

### CROSS REFERENCE TO RELATED APPLICATION

This application claims priority from Japanese Patent Application No. 2019-8049 filed on Jan. 21, 2019. The entire contents of the priority application are incorporated herein by reference.

### TECHNICAL FIELD

The technology described herein relates to a lighting device and a display device.

### BACKGROUND

There has been known a liquid crystal display device including a light source, a light guide plate, a prism sheet, and a liquid crystal panel. The light guide plate is for guiding light from the light source. The prism sheet is for collecting light that exits the light guide plate. The light that has exited the prism sheet enters the liquid crystal panel and an image is displayed on the liquid crystal panel. The liquid crystal panel includes substrates that sandwich a liquid crystal layer therebetween and a pair of polarizing plates that are disposed on outer surfaces of the substrates, respectively. Such a liquid crystal display device is described in Japanese Unexamined Patent Application Publication No. 2011-247948.

In such a liquid crystal display device having the above configuration, colored interference fringes, which is called iridescent unevenness, may be caused on the display surface of the liquid crystal panel. A diffuser sheet for diffusing light may be disposed between the light guide plate and the prism sheet or between the prism sheet and the liquid crystal panel such that the iridescent unevenness is less likely to be seen on the liquid crystal panel. However, if the liquid crystal display device includes the diffuser sheet, light is likely to be diffused toward the outer peripheral portions of the liquid crystal display device and luminance of the middle portion of the liquid crystal panel (front luminance) may be lowered. Further, if including the diffuser sheet, the liquid crystal display device may not be reduced in thickness thereof due to the thickness of the diffuser sheet.

### SUMMARY

The technology described herein was made in view of the above circumstances. An object is to achieve less occurrence of iridescent unevenness and improve front luminance and reduce thickness.

To solve the above problems, a lighting device of the present technology includes a light source, a light guide plate including an edge surface as a light entering surface through which light from the light source enters and one of a pair of plate surfaces as a light exit surface through which the light exits, and a light collecting sheet disposed to cover the light exit surface and applying a light collecting effect to the light exiting through the light exit surface. The light collecting sheet includes a base member having a sheet shape and a non-birefringence property and a light collecting layer disposed on a plate surface of the base member.

The iridescent unevenness occurs due to birefringence of the light in the base member of the light collecting sheet while passing through the light collecting sheet (for example, a prism sheet). Therefore, by using the base member having a non-birefringence property in the light collecting sheet, iridescent unevenness is less likely to occur. Further, with such a configuration, a diffuser sheet is not necessary as a means for restricting occurrence of iridescent unevenness. As a result, since the diffuser sheet is not included, the light is less likely to be diffused toward the outer peripheral portion of the lighting device and the front luminance can be increased. Furthermore, since the diffuser sheet is not included, the lighting device can reduce a thickness thereof.

According to the technology described herein, iridescent unevenness is less likely to occur and front luminance is increased and thickness is reduced.

### BRIEF DESCRIPTION OF THE DRAWINGS

FIG. 1 is an exploded perspective view of a liquid crystal display device according to a first embodiment of the present technology.

FIG. 2 is a cross-sectional view of the liquid crystal display device taken along II-II line in FIG. 1.

FIG. 3 is a cross-sectional view of the liquid crystal display device taken along III-III line in FIG. 1.

FIG. 4 is a perspective view illustrating exit light reflecting portions of a light guide plate seen from an opposite plate surface side.

FIG. 5 is a plan view illustrating the exit light reflecting portions of the light guide plate seen from the opposite plate surface side.

FIG. 6 is Table 1 describing experiment results of Comparative Experiment 1.

FIG. 7 is Table 2 describing experiment results of Comparative Experiment 2.

FIG. 8 is an exploded perspective view of a liquid crystal display device according to a second embodiment.

FIG. 9 is a cross-sectional view of a liquid crystal display device taken along IX-IX line in FIG. 8.

FIG. 10 is a cross-sectional view of the liquid crystal display device taken along X-X line in FIG. 8.

FIG. 11 is an exploded perspective view of a liquid crystal display device according to a third embodiment.

FIG. 12 is a cross-sectional view of a liquid crystal display device taken along XII-XII line in FIG. 11.

FIG. 13 is a cross-sectional view of the liquid crystal display device taken along XIII-XIII line in FIG. 11.

### DETAILED DESCRIPTION

### First Embodiment

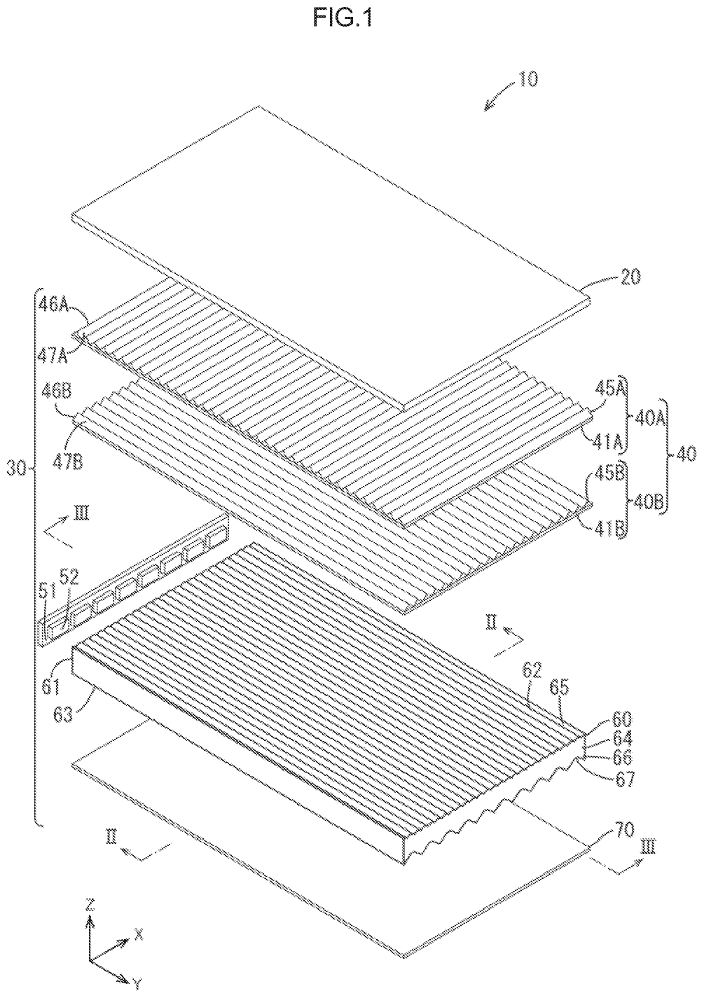

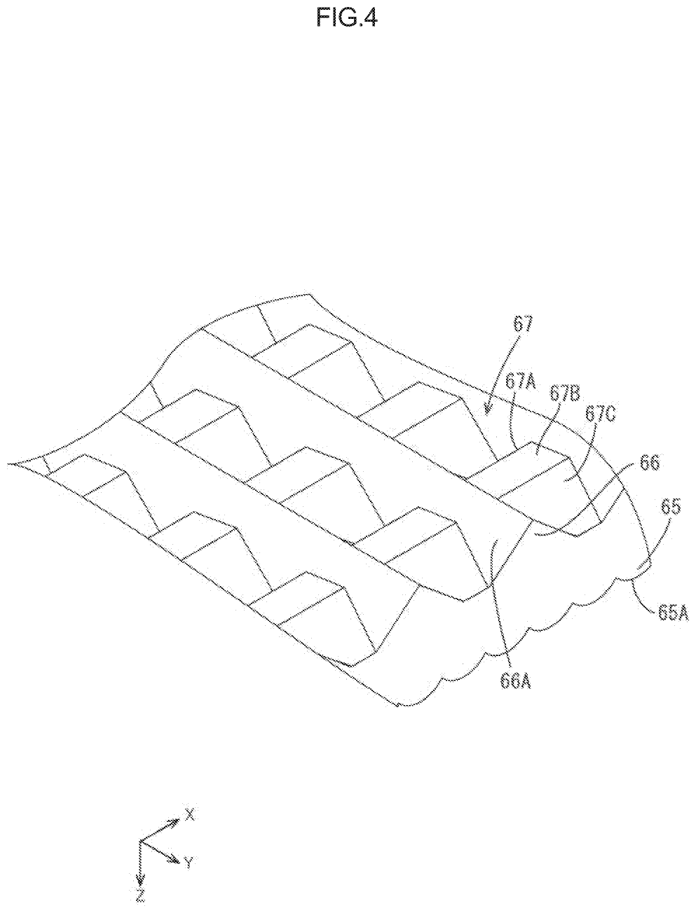

A first embodiment of the present technology will be described with reference to FIGS. 1 to 5. In the present embodiment section, a liquid crystal display device 10 (one example of a display device) will be described as an example. X-axis, the Y-axis and the Z-axis may be present in the drawings and each of the axial directions represents a direction represented in each drawing. +Z-axis direction and −Z-axis direction represent front and back sides, respectively.

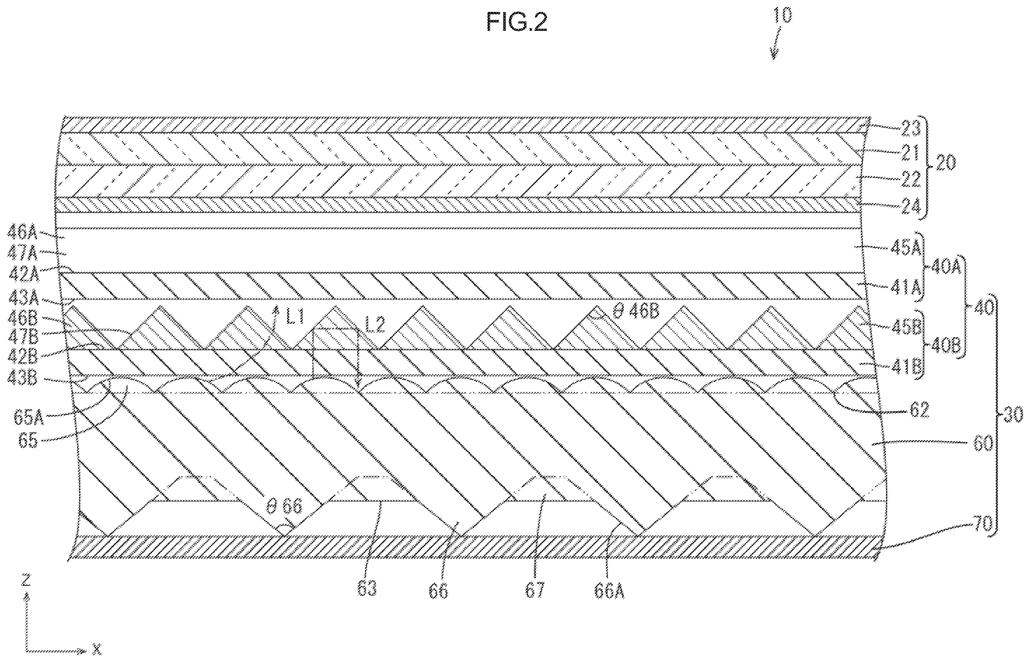

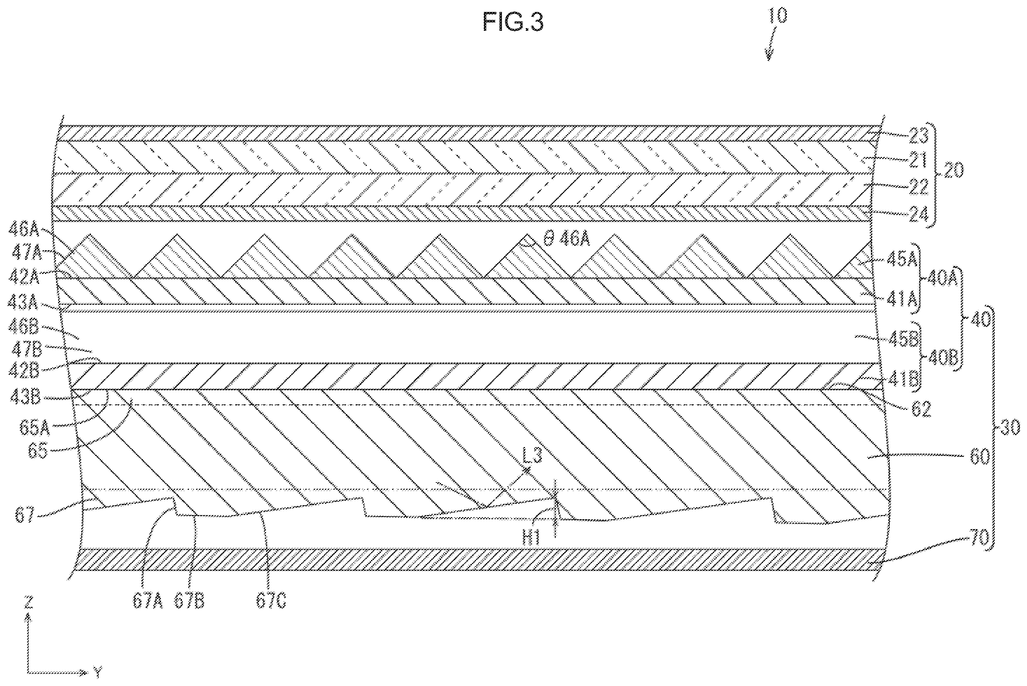

As illustrated in FIGS. 1 to 3, the liquid crystal display device 10 has a laterally-long rectangular shape (a quadrangular shape) as a whole, and at least includes a liquid crystal panel 20 (one example of a display panel) and a backlight device 30 (one example of a lighting device). Images are displayed on the liquid crystal panel 20. The backlight device 30 is arranged on a back side of the liquid crystal panel 20 and provides light to the liquid crystal panel 20. As illustrated in FIGS. 2 and 3, the liquid crystal panel 20 includes a pair of transparent substrates 21, 22 and a liquid crystal layer that is sealed in an inner space between the substrates 21, 22. The liquid crystal layer includes liquid crystal molecules having optical characteristics that change according to application of the electric field. Polarizing plates 23, 24 are bonded to outer surfaces of the substrates 21, 22, respectively.

As illustrated in FIGS. 1 to 3, the backlight device 30 includes LEDs 52 (light emitting diodes, one example of a light source), an LED board 51 where the LEDs 52 are mounted, a light guide plate 60 that guides light from the LEDs 52, a prism sheet 40 (one example of a light collection sheet) that collects light exiting the light guide plate 60, and a light reflection sheet 70 that reflects light that leaks from the light guide plate 60 toward the light guide plate 60. The above components are arranged within a chassis. The backlight device 30 includes the LEDs 52 arranged along one short-side edge portion thereof and light from the LEDs 52 enters the light guide plate 60 through one side surface thereof. The backlight device 30 is an edge-light type (a side-light type). Next, each of the components of the backlight device 30 will be described in detail.

As illustrated in FIG. 1, the LEDs 52 are arranged at equal intervals on a surface (a mount surface) of the LED board 51 in a line. The LED board 51 is a thin and long plate member extending along one short-side of the light guide plate 60 and is arranged to be away from the light guide plate 60 with a certain space and adjacent to a side surface (an edge surface, a light entering surface) of the light guide plate 60. The LED board 51 is made of metal such as aluminum, for example, and includes a wiring on the mount surface thereof via an insulator. The LEDs 52 are electrically connected to each other by the wiring and supplied with current. The LEDs 52 are white LEDs that emit white light and the LEDs 52 are configured by enclosing blue LED chips (blue light emitting elements) that emit light of a single color of blue with sealing material that includes a phosphor (green phosphor, red phosphor) with being dispersed and oriented. The LEDs 52 may further include LED chips that emit light of a single color and multiple kinds of single color LED chips emitting different colors (for example, blue, green, red) may be arranged in combination to obtain white color.

As illustrated in FIGS. 1 to 3, the reflection sheet 70 has a laterally-long rectangular plan view shape similar to that of the liquid crystal panel 20. The reflection sheet 70 is made of synthetic resin and has a white surface having good light reflectivity. The reflection sheet 70 is disposed on a rear side plate surface 63 (an opposite plate surface) of the light guide plate 60 and reflects light that leaks from the light guide plate 60 and the LEDs 52 toward the light guide plate 60.

The prism sheet 40 has flexibility and has a laterally-long rectangular plan view shape similar to the liquid crystal panel 20, as illustrated in FIGS. 1 to 3. The prism sheet 40 is disposed between the liquid crystal panel 20 and the light guide plate 60 such that a predefined light collecting effect is added to the light exiting the light guide plate 60 and the light exits the prism sheet 40 toward the toward the liquid crystal panel 20. The prism sheet 40 in this embodiment includes two prism sheets that are disposed on top of each other. The prism sheet 40 on the front side (the liquid crystal panel 20 side) is an upper prism sheet 40A and the prism sheet 40 on the back side (the light guide plate 60 side) is a lower prism sheet 40B. Hereinafter, in distinguishing between the upper prism sheet and the lower prism sheet, the alphabet A or B is added to the symbol and the alphabets may be omitted to generally referring the prism sheet.

As illustrated in FIGS. 1 to 3, the prism sheet 40 includes a base member 41 of a sheet-shape and a prism layer 45 (one example of a light collecting layer) that is disposed on a front side plate surface (a light exit-side plate surface 42) of a pair of plate surfaces of the base member 41. The prism layer includes unit prisms 46 each of which linearly extends. The unit prism 46 has a constant width dimension over an entire length thereof and has a triangular mountain cross-sectional shape. Light is reflected and refracted by sloped surfaces 47 of a mountain shape so that a light collecting effect is added to the light that passes through the unit prism 46 with respect to a direction in which the unit prisms 46 are arranged. If a vertex angle 846 (an interior angle at a top of the mountain shape) of the unit prism 46 is set from 80° to 90°, light rays can be effectively collected.

The upper prism sheet 40A includes the unit prisms 46A extending along the X-axis direction such that ridgelines of the mountain shape extend along the X-axis direction. The lower prism sheet 40B includes the unit prisms 46B extending along the Y-axis direction such that ridge lines of each mountain shape extend along the Y-axis direction. Therefore, the ridgeline direction (the X-axis direction) of the unit prisms 46A of the upper prism sheet 40A and the ridgeline direction (the Y-axis direction) of the unit prisms 46B of the lower prism sheet 40B are perpendicular to each other and cross.

The light collecting effect of the prism sheet 40 having the above configuration will be described. When light enters the lower prism sheet 40B from the light guide plate 60 side, the light passes through an air layer between a front side plate surface 62 (a light exit surface) of the light guide plate 60 and the base member 41B of the lower prism sheet 40B and enters the base member 41B through a back side plate surface 43B (a light entering-side plate surface) of the base member 41B. Therefore, the light is refracted at a border surface therebetween according to the angle of incident. When the light passing through the base member 41B exits the base member 41B through a light exit-side plate surface 42B and enters the unit prisms 46B, the light is refracted at a border surface therebetween according to the angle of incident. The light travelling through the unit prisms 46B reaches the sloped surfaces 47B of the unit prisms 46B. If the angle of incident on the sloped surface 47B is not greater than the critical angle, the light is refracted by the border surface and exits the unit prism 46B (illustrated by an arrow L1 in FIG. 2). If the angle of incident on the sloped surface 47B is greater than the critical angle, the light is totally reflected by the sloped surface 47B and returned toward the base member 41B (retroreflection) (illustrated by an arrow L2 in FIG. 2). Such a light collecting effect is added to the light entering the unit prisms 46B along the X-axis direction but almost not added to the light entering the unit prisms 46B along the Y-axis direction. Therefore, the light rays exiting the lower prism sheet 40B are collected with respect to the arrangement direction (the X-axis direction) of the unit prisms 46B such that the travelling direction of the exit light rays corresponds to the front direction (the +Z-axis direction, a normal direction to the light exit-side plate surface 42). Next, when the light exiting the lower prism sheet 40B enters the upper prism sheet 40A, the light rays exiting the upper prism sheet 40A are collected with respect to the arrangement direction (the Y-axis direction) of the unit prisms 46A such that the travelling direction of the exit light rays corresponds to the front direction by the same mechanism. Therefore, the two unit prisms 46A, 46B are arranged such that the ridgelines of the two unit prisms cross and the light collecting directions thereof also cross. This further unifies the luminance distribution within a plane surface and increases a view angle.

The base member 41 of the prism sheet 40 is made of resin that is highly transmissive. Particularly, the base member 41A of the upper prism sheet 40A is made of resin material having a non-birefringence property. Birefringence is caused by difference in the refractive indexes when the base member 41 has two or more refractive indexes due to influences of the crystal structure or the alignment of high molecules. In this specification, the phrase of “having a non-birefringence property” means “substantially has no birefringence property”. More specifically, the phrase is defined that the component substantially has no birefringence property (the birefringence property is zero) when the in-plane phase difference (a retardation value) that is obtained by multiplying difference between the refractive indexes and a film thickness is 10 nm or smaller. As will be obvious from results of Comparative Experiments, which will be described later, the base member 41 has the non-birefringence property that is defined by the retardation value of 10 nm or less so that the light passing through the upper prism sheet 40A is not refracted in two or more ways within the base member 41A. The birefringence is less likely to be caused in the base member 41A and accordingly, the light that has exited the upper prism sheet 40A and enters the liquid crystal panel 20 does not cause iridescent unevenness on the display surface of the liquid crystal panel 20.

The base member 41A having a sheet shape is obtained by melt-extruding non-crystalline resin material such as polycarbonate (PC) and a sheet of having the retardation value of 10 nm or less is obtained. The non-crystalline resin material includes a non-crystalline portion and is less likely to have difference in the refractive indexes caused by the crystalline structure. Therefore, the non-crystalline resin material has a small retardation value. In addition to PC, acrylic resin such as polymethyl methacrylate (PMMA) and triacetylcellulose (TAC) may be used as the non-crystalline resin material. PMMA and TAC have a high water absorbing property and are likely to cause warping by water absorption expansion under an environment of high temperature and high humidity. Therefore, PC is preferably used.

The base member 41B of the lower prism sheet 40B is made of resin that is highly transmissive and may not necessarily have a non-birefringence property. As will be obvious from results of Comparative Experiments, which will be described later, the birefringence of the base member 41B is less likely to influence occurrence of the iridescent unevenness. Therefore, the base member 41B may have or may not have a non-birefringence property. Specifically, the base member 41B may be made of crystalline transparent resin material such as polyethylene terephthalate (PET), and the crystalline transparent resin material is stretched with the biaxially stretching process to form a sheet of the base member. The crystalline resin material may be formed in a sheet with melt-extruding. In such a method, the sheet is likely to have low transparency due to the difference in the refraction indexes of the crystalline portion and the non-crystalline portion. Therefore, in using the crystalline transparent resin material, the base member having high transparency that is produced with the stretching process is preferably used.

The base member 41B may be made of the resin material having the non-birefringence property similar to that of the base member 41A of the upper prism sheet 40A. In such a configuration, when the light exiting the light guide plate 60 has a certain polarization state, the light passes through the lower prism sheet 40B and the upper prism sheet 40A while maintaining the certain polarization state. If the light with the certain polarization state exits the upper prism sheet 40A toward the liquid crystal panel 20 in parallel to the transmission axis of the polarizing plates 23, 24 of the liquid crystal panel 20, the light transmittance is increased and the luminance of the liquid crystal display device 10 can be improved. On the other hand, if the base member 41B has no non-birefringence property and the light exiting the light guide plate 60 has a certain polarization state, the certain polarization is disordered when the light is transmitted through the base member 41B. Therefore, some of the light rays have a polarization axis that is not parallel to the transmission axis of the polarizing plates 23, 24 and the light transmittance is lowered when the light is transmitted through the polarizing plates 23, 24. Since the base member 41A and the base member 41B have the non-birefringence property (the base members 41A, 41B of all of the prism sheets 40A, 40B have the non-birefringence property), the light transmittance is less likely to be lowered and high luminance of the liquid crystal display device 10 is maintained.

The prism layer 45 is made of ultraviolet curing resin having high transparency. A metal mold is filled with a raw material of the ultraviolet curing resin and the raw material is irradiated with ultraviolet rays to be cured while an opening edge of the metal mold being contacted with the light exit side plate surface 42 of the base member 41. Thus, the unit prisms 46 having a mountain-shaped cross section are formed on the prism layer 45. The refractive index of the prism layer 45 can be altered as appropriate by adjusting a blending ratio of the ultraviolet curing resin. In this embodiment, the refractive index of the prism layer 45A of the upper prism sheet 40A is adjusted to a relatively low range from 1.60 to 1.63 and the refractive index of the prism layer 45B of the lower prism sheet 40B is adjusted to a relatively low range from 1.49 to 1.52. Generally, the light collecting ability is increased as the refractive index of the prism layer 45 becomes higher. However, as the refractive index becomes higher, difference in the reflectance caused by the wavelengths becomes greater when the light is reflected by the sloped surface 47 of the mountain-shaped unit prism 46. Specifically, as the wavelength of the light becomes shorter (blue), the reflectance becomes higher and the exiting light is yellowish white and white balance is lost. In this embodiment, the refraction index of the prism layer 45B of the lower prism sheet 40B is adjusted to be relatively low so that the light (the light exiting the prism sheet 40) supplied to the liquid crystal panel 20 can keep good white balance.

As illustrated in FIGS. 1 to 3, the light guide plate 60 has a laterally-long rectangular plan view shape similar to that of the liquid crystal panel 20 and is a plate having a thickness greater than that of the prism sheet 40. The light guide plate 60 is made of resin having a refractive index much higher than that of air and high transparency (for example, acrylic resin such as PMMA and polycarbonate). The light emitted by the LEDs 52 in the Y-axis direction enters the light guide plate 60 through the light entering surface 61 and the light travels within the light guide plate 60 toward the prism sheet 40 and exits the light guide plate 60 through the light exit surface 62.

The light guide plate 60 integrally includes lens portions 65 on the light exit surface 62 and each of the lens portions 65 has a semicircular columnar shape. The light guide plate 60 integrally includes prism portions 66 (one example of a light collecting portion) and exit light reflecting portions 67 on an opposite plate surface 63. Each of the prism portions 66 projects toward a back side (a reflection sheet 70 side) and has a mountain-shaped cross section. Each of the exit light reflecting portions 67 is disposed between the adjacent prism portions 66. Generally, luminance unevenness is likely to be caused in the backlight device including no diffuser sheet. The backlight device 30 in this embodiment includes the above-described components in the light guide plate 60 to achieve less occurrence of the luminance unevenness and can provide light having high front luminance. Next, each of the components will be described in detail.

As illustrated in FIGS. 1 to 3, the lens portions 65 have a semicircular column shape extending along the Y-axis direction and are arranged in the X-axis direction. The lens portions 65 configure a lenticular lens. The light travelling within the light guide plate 60 is dispersed by the lens portions 65 with respect to the X-axis direction and exits the light guide plate 60 toward the liquid crystal panel 20. The exit light is collected in the arrangement direction of the lens portions 65 (the X-axis direction). More in detail, some the light rays that have reached the surface (an arched surface 65A) of the lens portions 65 enter at an angle of incident on the arched surface 65A that is greater than the critical angle and are totally reflected by the arched surface 65A and returned toward the opposite plate surface 63 and diffused with respect to the X-axis direction at the time of total reflection. On the other hand, some of the light rays that have reached the arched surface 65A of the lens portions 65 enter at an angle of incident on the arched surface 65A that is equal to or less than the critical angle and are refracted by the arched surface 65A and exit through the light exit surface 62. Some of the light rays that are refracted by the arched surface 65A are collected with respect to the X-axis direction. The light rays that are collected by the lens portions 65 with respect to the X-axis direction are likely to be collected by the lower prism sheet 40B with respect to the X-axis direction and the front luminance is likely to be increased.

As illustrated in FIGS. 1 to 3, the prism portions 66 extend linearly along the Y-axis direction and are arranged in the X-axis direction. Each of the prism portions 66 has a constant width dimension over an entire length thereof and has a mountain-shaped cross section (a triangular shape) that projects from the opposite plate surface 63 toward the rear side. By providing the prism portions 66, the light that travels within the light guide plate 60 is reflected and diffused by the sloped surfaces of the prism portions 66 such that the light exiting the light guide plate 60 has less luminance unevenness in the X-axis direction. Since the LEDs 52 are point light sources, portions of the light entering surface 61 of the light guide plate 60 that correspond to spaces between the adjacent LEDs 52 are likely to be dark portions and this may cause luminance unevenness in the X-axis direction in which the LEDs 52 are arranged. By providing the prism portions 66 in addition to the lens portions 65, the light is diffused in the X-axis direction and luminance unevenness in the X-axis direction is less likely to be caused by the synergetic effect of the lens portions 65 and the prism portions 66. To improve the synergetic effect of the diffusing property, the prism portions 66 and the lens portions 65 preferably differ in at least one of the shape and the width dimension. In this embodiment, the prism portion 66 has a triangular shape and the triangular shape has a cross sectional shape having a vertex angle 866 of about 140°. The shape of the prism portion 66 differs from that of the lens portion 65 having a semicircular cross section. Further, the width dimension of the prism portion 66 is much greater than the width dimension of the lens portion 65.

As illustrated in FIGS. 1 to 5, each of the exit light reflecting portions 67 extends along the Y-axis direction and is disposed between the two adjacent prism portions 66 (in a prism portion in-between portion). The exit light reflecting portions 67 include prism portions each having a polygonal shape. Each prism portion has three sloped surfaces (a first sloped surface 67A, a second sloped surface 67B, a third sloped surface 67C) having different inclination angles. As illustrated in FIGS. 2 to 5, the first sloped surface 67A, the second sloped surface 67B, and the third sloped surface 67C connect two sloped surfaces 66A of the two respective prism portions 66 opposite to each other. As illustrated in FIG. 3, the first sloped surface 67A and the second sloped surface 67B are inclined closer to the reflection sheet 70 (the lower side in FIG. 3) as they extend farther away from the LEDs 52 (the light entering surface 61) in the Y-axis direction. The second sloped surface 67B is continuous from one end (an end farther from the LEDs 52) of the first sloped surface 67A and the inclination angle of the second sloped surface 67B with respect to the Y-axis direction is smaller than the inclination angle of the first sloped surface 67A. The third sloped surface 67C is continuous from one end (an end farther from the LEDs 52) of the second sloped surface 67B and is inclined closer to the light exit surface 62 (the upper side in FIG. 3) as it extends farther away from the LEDs 52 in the Y-axis direction.

With such exit light reflecting portions 67, when the light travelling within the light guide plate 60 from the LEDs 52 side along the +Y-axis direction (from the left side to the right side in FIG. 3) hits the third sloped surface 67C at an angle of incident that is equal to or greater than the critical angle, the light is reflected by the third sloped surface 67C toward the light exit surface 62 (one example of such light is indicated by an arrow L3 in FIG. 3). The light is directed toward the light exit surface 62 by the third sloped surfaces 67C and the third sloped surfaces 67C accelerate the light to exit through the light exit surface 62. The light that is returned from the edge surface 64 that is opposite from the light entering surface 61 (the edge surface close to the LEDs 52) (from the right side to the left side in FIG. 3) reflects off the first sloped surfaces 67A toward the light exit surface 62. Furthermore, the light rays within the light guide plate 60 are collected by the second sloped surfaces 67B and this increases directivity.

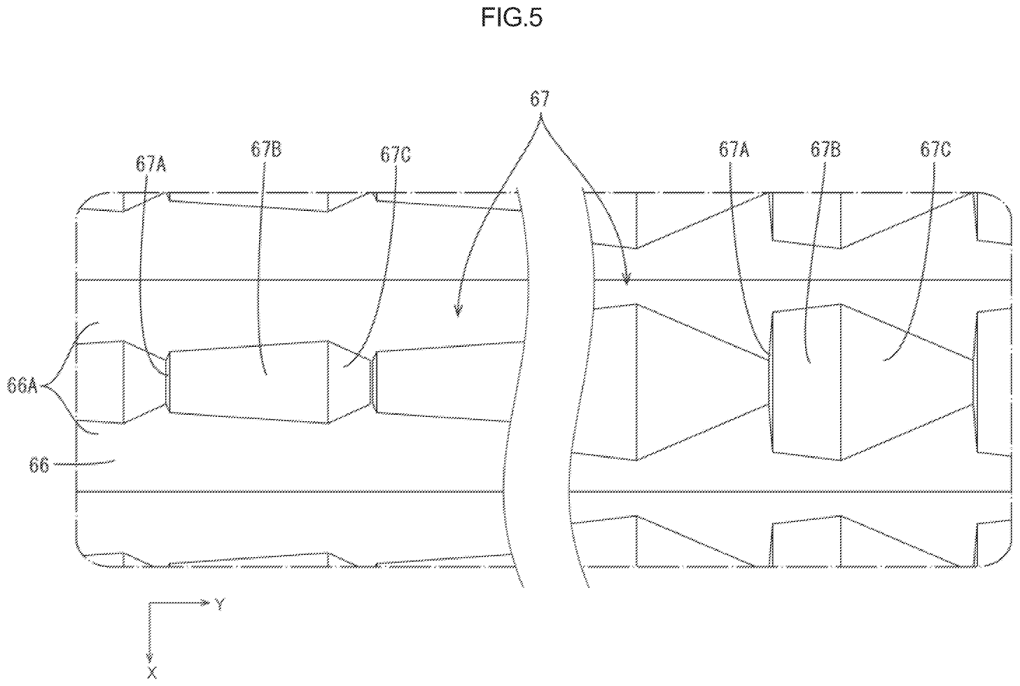

The third sloped surfaces 67C are arranged in the Y-axis direction (a normal direction to the light entering surface 61). As illustrated in FIG. 5, the third sloped surfaces 67C are designed such that an area thereof is increased as the position of the third sloped surface 67C is farther away from the LEDs 52 (the height H1 of the third sloped surface 67C in FIG. 3 is increased in a stepwise manner as the position of the third sloped surface 67C is farther away from the LEDs 52). According to such a design, the exiting of light through the light exit surface 62 is further accelerated as the position in the light guide plate is farther away from the LEDs 52. Therefore, luminance unevenness between the portion closer to the LEDs 52 and the portion farther away from the LEDs 52 is less likely to be caused.

As described above, the backlight device 30 in this embodiment includes the LEDs 52, the light guide plate 60, and the prism sheet 40. The light guide plate 60 includes the light entering surface 61 that is an edge surface thereof and through which light from the LEDs 52 enters and the light exit surface 62 that is one of a pair of plate surfaces and through which the light exits. The prism sheet 40 is disposed to cover the light exit surface 62 and applies a light collecting effect to the light that has exited through the light exit surface. The prism sheet 40 includes the base member 41 of a sheet shape having a non-birefringence property and the prism layer 45 that is disposed on a plate surface of the base member 41.

The iridescent unevenness occurs due to birefringence of the light in the base member 41 while passing through the prism sheet 40. If the light rays that create phase difference due to the birefringence interfere with each other in the liquid crystal panel 20, interference fringes (iridescent unevenness) may be caused. Since the base member 41 of the prism sheet 40 has a non-birefringence property, the birefringence does not occur in the base member 41 and iridescent unevenness is less likely to occur. Further, with such a configuration, a diffuser sheet is not necessary as a means for restricting occurrence of iridescent unevenness. As a result, since the diffuser sheet is not included, the light is less likely to be diffused toward the outer peripheral portion of the backlight device 30 and the front luminance can be increased. Furthermore, since the diffuser sheet is not included, the backlight device 30 can reduce a thickness thereof.

The prism sheet 40 includes multiple prism sheets 40 (the upper prism sheet 40A and the lower prism sheet 40B) and the base member 41A of at least the upper prism sheet 40A that is farthest away from the light guide plate 60 (closest to the liquid crystal panel 20) has a non-birefringence property. In the prism sheet 40 including the prism sheets 40, if the base member 41A of the upper prism sheet 40A, which is closest to the liquid crystal panel 20, has a birefringence property, iridescent unevenness is likely to occur. Therefore, at least the base member 41A has a non-birefringence property so that the occurrence of iridescent unevenness is reduced.

The retardation value of the base member 41 having a non-birefringence property is 10 nm or less. Accordingly, the occurrence of the iridescent unevenness is surely restricted.

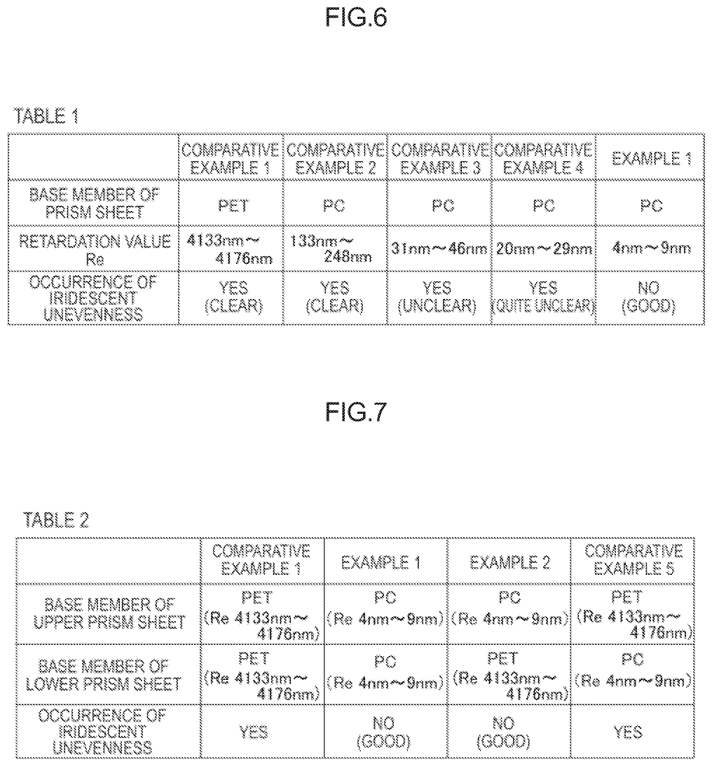

To prove the above operations and effects, Comparative Experiment 1 and Comparative Experiment 2 were performed. Results of Comparative Experiment 1 and Comparative Experiment 2 are illustrated in Table 1 (FIG. 6) and Table 2 (FIG. 7).

### Comparative Experiment 1

In Comparative Experiment 1, the base members each including the material and the retardation value illustrated in Table 1 are used for the upper prism sheet 40A and the lower prism sheet 40B and the upper prism sheet 40A and the lower prism sheet 40B are included in the liquid crystal display device 10. In each of such configurations, occurrence of iridescent unevenness on the liquid crystal panel 20 was evaluated. Each of the base members 41A, 41B used in Example 1, Comparative Example 2, Comparative Example 3, and Comparative Example 4 is obtained by melt-extruding PC to form a sheet and each of the base members 41A, 41B used in Comparative Example 1 is obtained by stretching PET with the biaxially stretching process to form a sheet. The retardation values of the base members 41A, 41B have a wide variation within a surface area and therefore, Table 1 represents value ranges each including the variation. As is obvious from Table 1, in Comparative Example 1 to Comparative Example 4, the retardation value of each of the base members 41A, 41B is greater than 10 nm and iridescent unevenness is recognized and display quality is not good. In Comparative Example 1 having the highest retardation value, the iridescent unevenness is clearly recognized. The iridescent unevenness tends to be unclear as the retardation value becomes smaller from Comparative Example 2 to Comparative Example 4. On the other hand, in Example 1, the retardation value of the base members 41A, 41B is 10 nm or less and the iridescent unevenness is not recognized and it was confirmed that the iridescent unevenness is cancelled.

### Comparative Experiment 2

In Comparative Experiment 2, the base members each including the material and the retardation value illustrated in Table 2 are used for the upper prism sheet 40A and the lower prism sheet 40B, respectively, and the upper prism sheet 40A and the lower prism sheet 40B are included in the liquid crystal display device 10. In each of such configurations, occurrence of iridescent unevenness on the display surface of the liquid crystal panel 20 was evaluated. In Comparative Experiment 1, the same base member was used in the upper prism sheet 40A and the lower prism sheet 40B. In Comparative Experiment 2, the same type of base members or different types of base members were used in the upper prism sheet 40A and the lower prism sheet 40B. Other configurations are same in Comparative Experiment 1 and Comparative Experiment 2. Example 1 and Comparative 1 are same in Comparative Experiment 2 as those in Comparative Experiment 1.

In Comparative Example 5, the retardation value of the base member 41B included in the lower prism sheet 40B is 10 nm or less and the retardation value of the base member 41A included in the upper prism sheet 40A is greater than 10 nm and iridescent unevenness was recognized. On the other hand, in Example 2, the retardation value of the base member 41B is greater than 10 nm and the retardation value of the base member 41A is 10 nm or less and iridescent unevenness was not recognized. Accordingly, it was confirmed that the occurrence of iridescent unevenness is greatly influenced by the base member 41A of the upper prism sheet 40A that is closest to the liquid crystal panel 20 (farthest away from the light guide plate 60) and at least the base member 41A preferably has a non-birefringence property, that is, has the retardation value of 10 nm or less.

### Second Embodiment

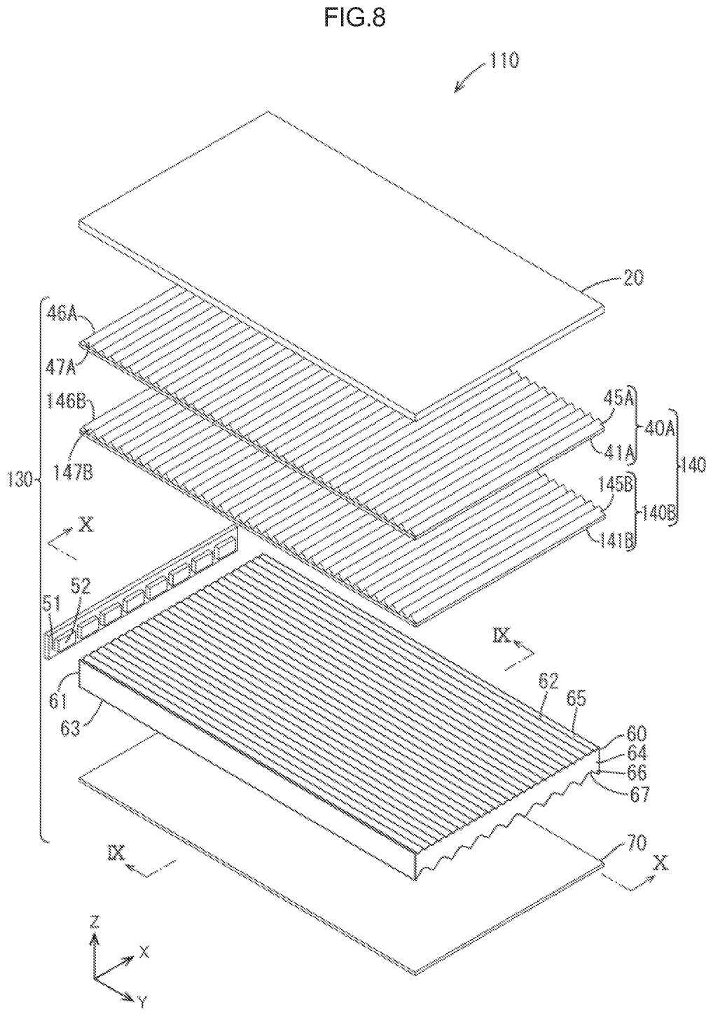

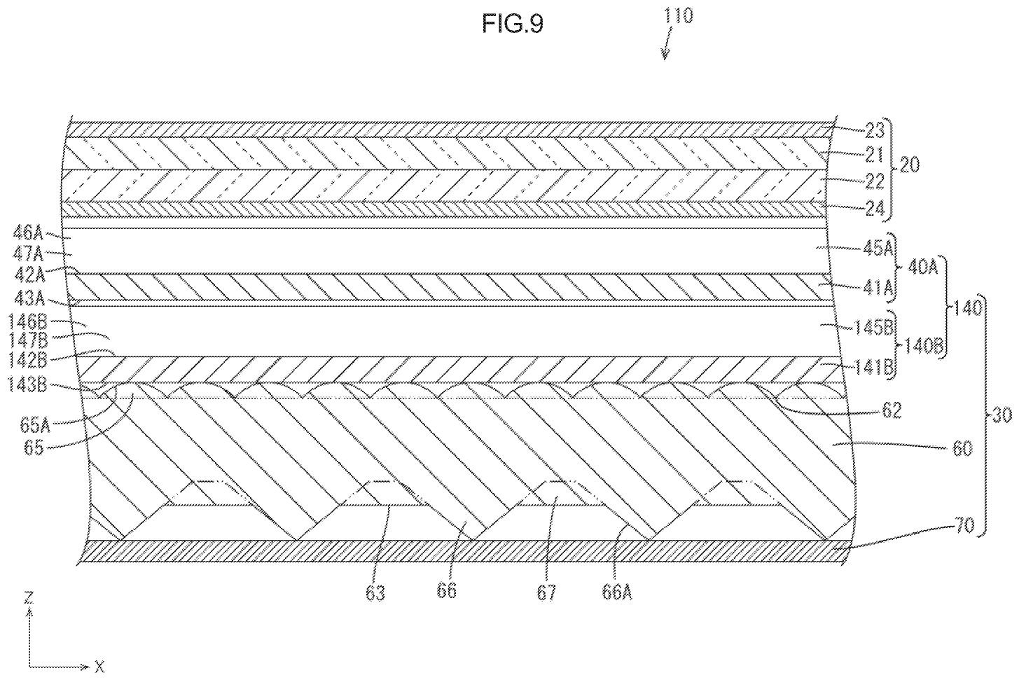

A liquid crystal display device 110 according to a second embodiment will be described with reference to FIGS. 8 to 10. In the second embodiment, a backlight device 130 includes a prism sheet 140 including a lower prism sheet 140B. The second embodiment differs from the first embodiment in that unit prisms 146B of the lower prism sheet 140B have a ridgeline direction that is parallel to the X-axis direction. Configurations, operations, and effects that are similar to those of the first embodiment will not be described.

In this embodiment, as illustrated in FIGS. 8 to 10, the unit prisms 146B of a prism layer 145B extend in the X-axis direction and a ridgeline of a mountain shape thereof is parallel to the X-axis direction. Similar to the first embodiment, the upper prism sheet 40A is formed such that the unit prisms 46A extend in the X-axis direction and the ridgeline of the mountain shape thereof is parallel to the X-axis direction. Therefore, the ridgeline direction (the X-axis direction) of the unit prisms 46A of the upper prism sheet 40A and the ridgeline direction (the X-axis direction) of the unit prisms 146B of the lower prism sheet 140B are parallel to each other and are the same direction (the X-axis direction).

According to such a configuration, the light rays are collected with respect to the arrangement direction (the X-axis direction) of the unit prisms 46A, 146B by both of the prism sheets 40A, 140B so as to travel in the front direction. The traveling direction of the light is changed in a stepwise manner such that the light travels toward the front direction. As a result, the front luminance of the light that is supplied to the liquid crystal panel 20 can be increased.

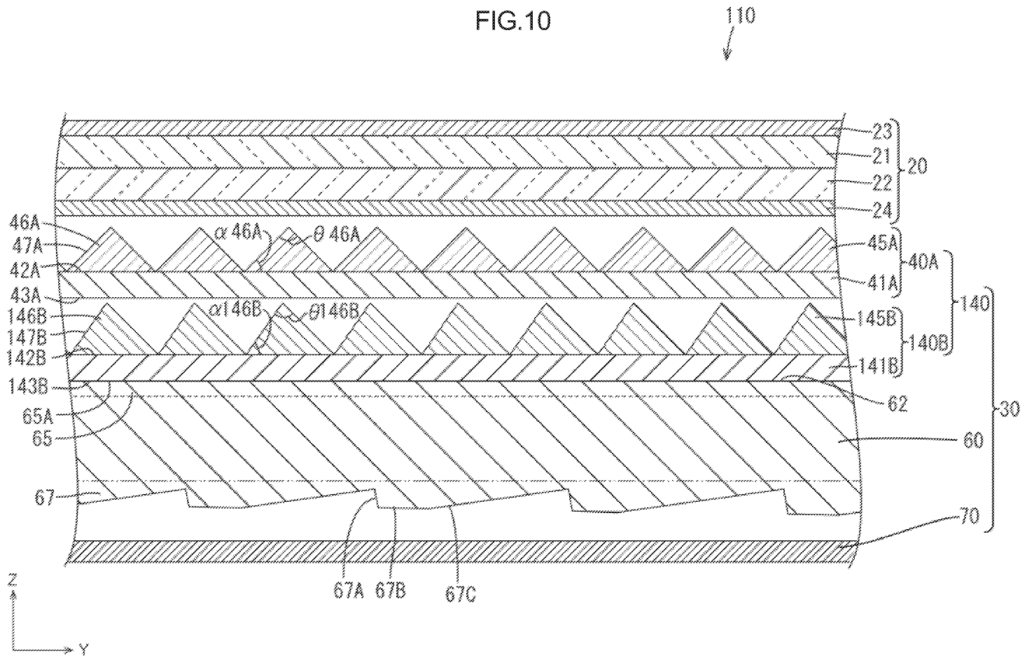

When the ridgelines of the unit prisms 46A, 146B are parallel to each other, a distance between the adjacent unit prisms 46A (a distance between the ridgelines) is preferably different from a distance between the adjacent unit prisms 146B to prevent occurrence of moire. Furthermore, as illustrated in FIG. 10, the unit prism 46A has a symmetrical triangular cross sectional shape (an isosceles triangle having the vertex angle θ46A=90° and an LED-side base angle α46A=45°) and the unit prism 146B has a symmetrical triangular cross sectional shape (a triangle having the vertex angle θ146B=80° and an LED-side base angle α146B=55°). The unit prisms 146B and the unit prisms 46A are designed such that the LED-side base angle α146B is greater than the LED-side base angle α46A. Accordingly, the light from the light guide plate 60 can be directed to the front direction more efficiently.

### Third Embodiment

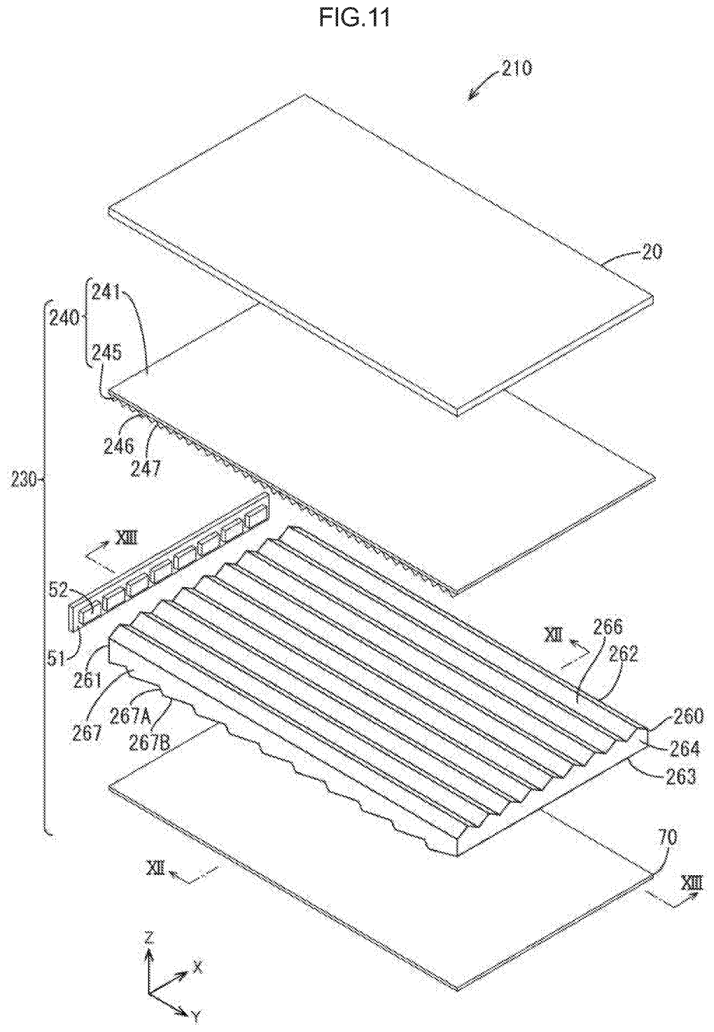

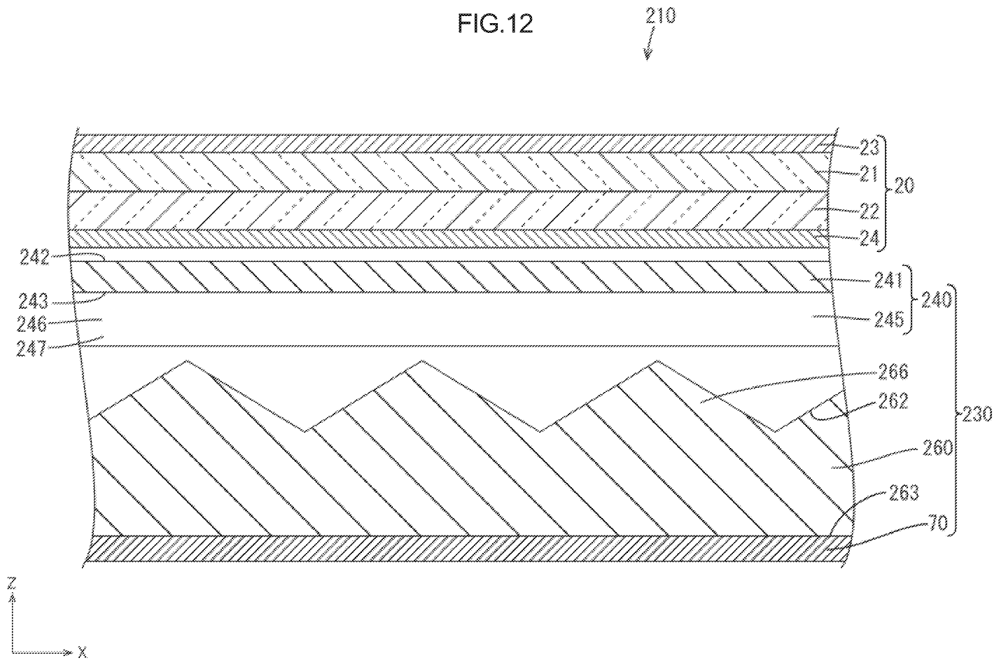

A liquid crystal display device 210 according to a third embodiment will be described with reference to FIGS. 11 to 13. In the third embodiment, a backlight device 230 includes a prism sheet 240 of one single sheet member. A shape of a light guide plate 260 in the third embodiment differs from that of the light guide plate 60 in the first embodiment and the second embodiment. Configurations, operations, and effects that are similar to those of the first embodiment and the second embodiment will not be described.

In this embodiment, as illustrated in FIGS. 11 to 13, a prism sheet 240 includes a base member 241 of a sheet and a prism layer 245 disposed on a plate surface of a pair of plate surfaces of the base member 241 opposite the light guide plate 260 (a light entering-side plate surface 243). The base member 241 has a non-birefringence property defined by the retardation value of 10 nm or less. The prism layer 245 includes unit prisms 246 that have a mountain-shaped cross sectional shape (a triangular shape) projecting from the light entering-side plate surface 243 toward the rear side. Each of the unit prisms 246 has a constant width dimension over an entire length thereof and extends linearly along the X-axis direction and the unit prisms 246 are arranged in the Y-axis direction.

As illustrated in FIGS. 11 to 13, the light guide plate 260 integrally includes prism portions 266 having a mountain-shaped cross sectional shape (a triangular shape) on a front side plate surface 262 (a light exit surface) and integrally includes exit light reflecting portions 267 projecting toward the rear side (toward the reflection sheet 70) on a rear side plate surface 263 (an opposite plate surface). Each of the prism portions 266 has a constant width dimension over an entire length thereof and extends linearly along the Y-axis direction and the prism portions 266 are arranged in the X-axis direction. The light entering the light guide plate 260 through the LED 52 side surface and travelling within the light guide plate 260 is diffused in the X-axis direction by the prism portions 266 and exits toward the liquid crystal panel 20. The exit light is collected in the arrangement direction of the prism portions 266 (the X-axis direction). On the other hand, the exit light reflecting portions 267 formed on the opposite plate surface 263 extend linearly along the X-axis direction while each having a constant width dimension and are arranged in the Y-axis direction. The exit light reflecting portion 267 has a non-symmetric mountain cross sectional shape (a triangular shape) and includes a pair of sloped surfaces 267A, 267B. The sloped surface 267B that is farther away from the LEDs 52 has an area greater than an area of the sloped surface 267A.

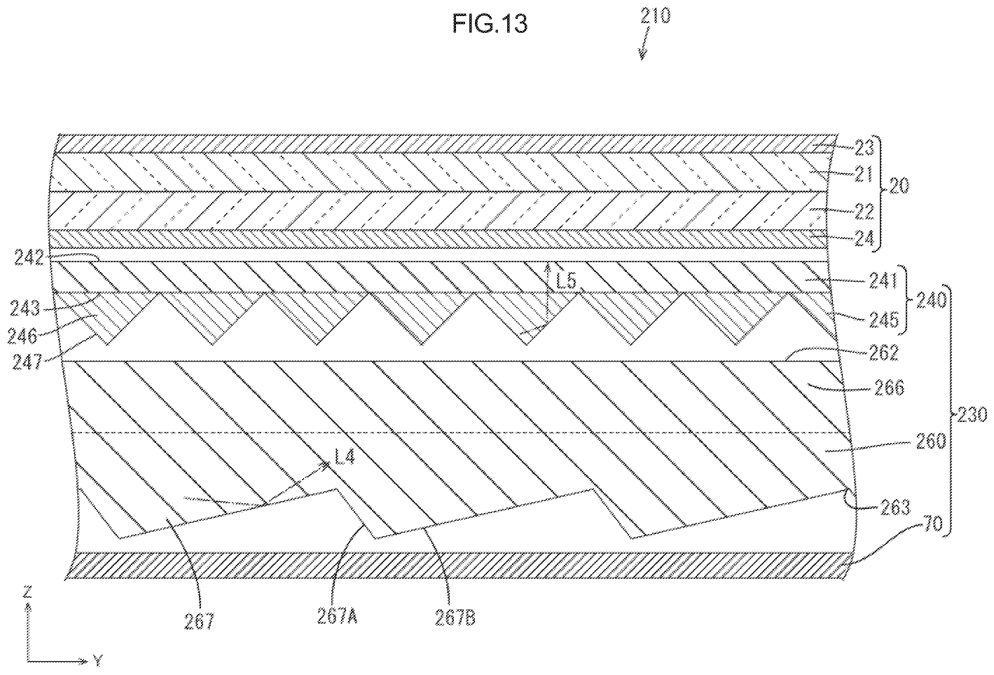

When the light travelling within the light guide plate 260 along the +Y-axis direction (from the left side to the right side in FIG. 13) hits the sloped surface 267B at an angle of incident that is equal to or greater than the critical angle, the light is reflected by the sloped surface 267B toward the light exit surface 62 (one example of such light is indicated by an arrow L4 in FIG. 13). The light is directed toward the front direction by the sloped surfaces 267B at an angle so as not to be totally reflected by the light exit surface 262 and to accelerate the light to exit through the light exit surface 262. The light that is returned from the edge surface 264 that is opposite from the light entering surface 261 (the edge surface close to the LEDs 52) (from the right side in FIG. 3) reflects off the sloped surfaces 267A toward the light exit surface 262. A large amount of the light rays travelling within the light guide plate 260 travel in the +Y-axis direction from the LEDs 52 toward the light guide plate 60. The sloped surface 267B that is farther away from the LEDs 52 has an area greater than an area of the sloped surface 267A so that the light can be directed in the front direction efficiently.

The light entering the prism sheet 240 from the light guide plate 260 side reaches the sloped surfaces 247 of the unit prisms 246. If the angle of incident on the sloped surface 247 is greater than the critical angle, the light is totally reflected by the sloped surface 247 and collected to be directed in the front direction (the +Z-axis direction, a normal direction to the light entering side plate surface 243) (illustrated by an arrow L5 in FIG. 13). The light from the light guide plate 260 is directed in the front direction by the unit prisms 246 efficiently so that the front luminance of the light supplied to the liquid crystal panel 20 can be increased. The light travelling through the prism sheet 240 is collected in the Y-axis direction (the arrangement direction of the unit prisms 246) so as to travel in the front direction.

According to the prism sheet 240 and the light guide plate 260 having the above configurations, the light supplied to the liquid crystal panel 20 is not diffused too much and has high directivity and therefore, the directivity of the light is easy to be controlled. Since the light can be directed toward the liquid crystal panel 20 efficiently, the front luminance can be increased. On the other hand, since the light has a low diffusing property, iridescent unevenness is likely to occur generally. However, in this embodiment, birefringence that may be caused in the base member 241 of the prism sheet 240 is controlled to control iridescent unevenness. Therefore, according to the present embodiment, the light having high directivity and high front luminance can be supplied to the liquid crystal panel 20 while the iridescent unevenness being controlled.

### Other Embodiments

The present technology is not limited to the embodiments described above with reference to the drawings. The following embodiments may be included in the technical scope.

(1) In each of the above embodiments, the prism sheet including the unit prisms is used as the light collecting sheet; however, it is not limited thereto. A light collecting sheet including cylindrical lenses may be used as the light collecting sheet.

(2) In each of the above embodiments, the melt-extruding method and the biaxially stretching process are used as the method of producing the base member of the prism sheet; however, other producing methods may be used.

(3) In each of the above embodiments, the light guide plate includes the lens portions or the prism portions (including the exit light reflecting portions) on both of the plate surfaces thereof. However, such shapes are examples and may be altered as appropriate. The light guide plate may not include such components and the plate surface itself may be a sloped surface. For example, the light exit surface may be processed with blasting and surface roughness thereof is increased to improve the light diffusing property.

(4) In each of the above embodiments, the LEDs are arranged opposite one side surface (an edge surface) of the light guide plate. However, the LEDs may be arranged opposite two side surfaces and the backlight device of a two-side light entering edge-light type may be used. A light source other than LEDs such as organic ELs may be used.

(5) In each of the above embodiments, the liquid crystal display device has a laterally-long rectangular overall shape but may have a vertically-long rectangular shape or other shapes.

1. A lighting device comprising:
a light source;
a light guide plate including an edge surface as a light entering surface through which light from the light source enters and one of a pair of plate surfaces as a light exit surface through which the light exits; and
a light collecting sheet disposed to cover the light exit surface and applying a light collecting effect to the light exiting through the light exit surface, the light collecting sheet including a base member having a sheet shape and a non-birefringence property and a light collecting layer disposed on a plate surface of the base member.

2. The lighting device according to claim 1, wherein the light collecting sheet includes light collecting sheets and at least one of the light collecting sheets that is disposed farthest from the light guide plate includes the base member having the non-birefringence property.

3. The lighting device according to claim 2, wherein all of the light collecting sheets include base members having the non-birefringence property.

4. The lighting device according to claim 1, wherein the base member having the non-birefringence property has a retardation value of 10 nm or less.

5. The lighting device according to claim 1, wherein the base member having the non-birefringence property is made of non-crystalline resin material.

6. The lighting device according to claim 2, wherein
the light collecting layer includes unit prisms each of which extends linearly and has a mountain-shaped cross sectional shape, and
the unit prisms included in the light collecting sheets have ridgeline directions that cross each other.

7. The lighting device according to claim 2, wherein
the light collecting layer includes unit prisms each of which extends linearly and has a mountain-shaped cross sectional shape, and
the unit prisms included in the light collecting sheets have ridgeline directions that are parallel to each other along a certain direction.

8. The lighting device according to claim 1, wherein the light guide plate includes
light collecting portions on one of plate surfaces of the light exit surface and an opposite plate surface that is opposite from the light exit surface, the light collecting portions arranged along a certain direction and projecting from the one of the surfaces and configured to collect light such that the light travels in a normal direction to the light exit surface, and
an exit light reflecting portion disposed between the light collecting portions that are adjacent to each other and by which light travelling within the light guide plate is reflected to accelerate the light to exit the light guide plate.

9. The lighting device according to claim 8, wherein
the exit light reflecting portion includes exit light reflecting portions that are arranged along a normal direction to the light entering surface,
the exit light reflecting portions have sloped surfaces that are inclined closer to one of the plate surfaces having no exit light reflecting portions as they extend farther away from the light source, and
the sloped surfaces of the exit light reflecting portions have a greater area as they are disposed to be farther away from the light source.

10. A display device comprising:
the lighting device according to claim 1; and
a display panel displaying images using light from the lighting device.

11. The display device according to claim 10, wherein the display panel includes
a pair of substrates,
a liquid crystal layer sealed between the substrates, and
a pair of polarizing plates disposed on plate surfaces of the substrates opposite from the liquid crystal layer.
